(19) United States
(12) Patent Application Publication
(10) Pub. No.: US 2023/0421363 A1
(43) Pub. Date: Dec. 28, 2023

(54) SECURE STORAGE AND TRANSMISSION OF A CRYPTOCURRENCY ENCRYPTION KEY

(71) Applicant: FMR LLC, Boston, MA (US)

(72) Inventor: David Lawrence Hill, North Smithfield, RI (US)

(21) Appl. No.: 17/852,120

(22) Filed: Jun. 28, 2022

(51) Int. Cl. H04L 9/08; H04L 9/32

(52) U.S. Cl. CPC H04L 9/0825; H04L 9/0869; H04L 9/3247; H04L 9/0852; H04L 2209/56; H04B 11/00

(57) ABSTRACT

Methods and apparatuses are described for secure storage and transmission of a cryptocurrency encryption key. The apparatus comprises a microprocessor, a security module comprising a memory storing a first private key and a first public key, a quantum computing module comprising a quantum chip with one or more qubits, a speaker, and a microphone. The microprocessor converts a random string generated by the quantum computing module into a second private key. The microprocessor creates a second public key using the second private key. The microprocessor encrypts the second private key using the first private key from the security module. The microprocessor generates a signature for the second public key using the first private key. The microprocessor generates, using the speaker, ultrasonic sound waves corresponding to the second public key and the signature, and transmits the ultrasonic sound waves to a remote computing device.

### TECHNICAL FIELD

This application relates generally to methods, systems, and apparatuses, including computer program products, for secure storage and transmission of a cryptocurrency encryption key.

### BACKGROUND

As cryptocurrency becomes more accepted as tender for transactions and people increase their cryptocurrency holdings, secure storage of wallet private keys has become paramount to ensure safety, integrity, and accessibility of cryptocurrency wallets and the assets therein. Presently, one solution is to allow a third party to manage and secure the private keys. In certain circumstances where a wallet balance is nominal, this arrangement may be acceptable. However, as the value and amount of assets in a cryptocurrency wallet increases, such third party management of private keys may become a significant liability—mismanagement, leaking, or loss of private keys by the third party would result in inaccessibility of, or even loss of, the assets.

As such, it may be more prudent to manage one's own private keys using a personal solution. Recently, computing devices such as cryptocurrency hardware wallets have been developed to provide a secure storage mechanism for private keys. Generally, most hardware wallets comprise a microprocessor, memory, and software to encrypt, store, and manage private keys for use in validating and signing cryptocurrency transactions. Most hardware wallets on the market today leverage USB communications and/or quick response (QR) codes to relay a wallet signature to a remote computing device for transaction processing. As can be appreciated, QR codes can provide some security, but they also provide an easy attack vector. As cameras are becoming more commonplace and constant recording/streaming of video is happening, the chances of QR information being intercepted and misused is extremely high. And, if the QR code is not encrypted, anyone who takes a picture or video recording of the code can easily decode it and know exactly what was shared—thereby compromising the security of the wallet and/or transaction.

Furthermore, current hardware wallets rely on some sort of entropy, e.g., a random number or user-provided string, to be used as a seed for generating private keys for cryptocurrency wallets. However, one of the biggest issues with computers is their somewhat limited ability to generate a random number. Typically, to generate a random number, the computer has to be fed an entropy from a user or from the system itself. The lack of complexity in generating the entropy may lead to less secure private keys and an increased chance that they may be compromised.

### SUMMARY

The apparatuses, methods, and systems described herein overcome the above-described deficiencies to provide an improved hardware wallet for cryptocurrency keys that uses a combination of highly-secure and tamper-resistant data storage, random number generation using advanced computing techniques, and difficult-to-intercept device communications to ensure a multilayered approach in keeping cryptocurrency keys secure.

The invention, in one aspect, features an apparatus for secure storage and transmission of a cryptocurrency encryption key. The apparatus comprises a microprocessor, a security module comprising a memory storing a first private key and a first public key, a quantum computing module comprising a quantum chip with one or more qubits, a speaker, and a microphone. The microprocessor converts a random string generated by the quantum computing module into a second private key. The microprocessor creates a second public key using the second private key. The microprocessor encrypts the second private key using the first private key from the security module. The microprocessor generates a signature for the second public key using the first private key. The microprocessor generates, using the speaker, ultrasonic sound waves corresponding to the second public key and the signature, and transmits the ultrasonic sound waves to a remote computing device.

The invention, in another aspect, features a computerized method of secure storage and transmission of a cryptocurrency encryption key. A memory of a security module stores a first private key and a first public key. A quantum chip of a quantum computing module generates a random string. A microprocessor converts the random string into a second private key. The microprocessor encrypts the second private key using the first private key. The microprocessor generates a signature for the second public key using the first private key. A speaker coupled to the microprocessor generates ultrasonic sound waves corresponding to the second public key and the signature, and transmits the ultrasonic sound waves to a remote computing device.

Any of the above aspects can include one or more of the following features. In some embodiments, the microphone listens for ultrasonic sound waves transmitted from the remote computing device. In some embodiments, the microprocessor converts the ultrasonic sound waves received by the microphone into unsigned cryptocurrency transaction data. In some embodiments, the microprocessor generates a transaction signature using the second private key and signs the unsigned cryptocurrency transaction data using the transaction signature. In some embodiments, the security module decrypts the second private key before the microprocessor generates the transaction signature. In some embodiments, the microprocessor transmits, using the speaker, ultrasonic sound waves corresponding to the signed cryptocurrency transaction data and the transaction signature to the remote computing device.

In some embodiments, the microprocessor validates the integrity of the security module before encrypting the second private key using the first private key. In some embodiments, the microprocessor validates the integrity of the quantum computing module before converting the random string into the second private key. In some embodiments, the random string comprises a 256-bit random number.

In some embodiments, the remote computing device generates a cryptocurrency wallet address using the second public key received from the microprocessor. In some embodiments, the remote computing device verifies the signature received from the microprocessor before generating the cryptocurrency wallet address. In some embodiments, the microprocessor encodes the second public key and the signature into one or more packets and generates the ultrasonic sound waves using the one or more packets. In some embodiments, the apparatus further comprises a circuit board that connects the microprocessor to the security module, the quantum computing module, the speaker, and the microphone. In some embodiments, the circuit board, the microprocessor, the security module, the quantum computing module, the speaker, and the microphone are within a single device housing.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for secure storage and transmission of a cryptocurrency encryption key.

FIG. 2 is a flow diagram of a computerized method of secure storage and transmission of a cryptocurrency encryption key.

FIG. 3 is a workflow diagram of a computerized method of pairing apparatus with remote computing device using a secure handshake process

FIG. 4 is a workflow diagram of a computerized method of signing a cryptocurrency transaction.

FIGS. 5A to 5E are diagrams of exemplary user interface screens generated by apparatus.

### DETAILED DESCRIPTION

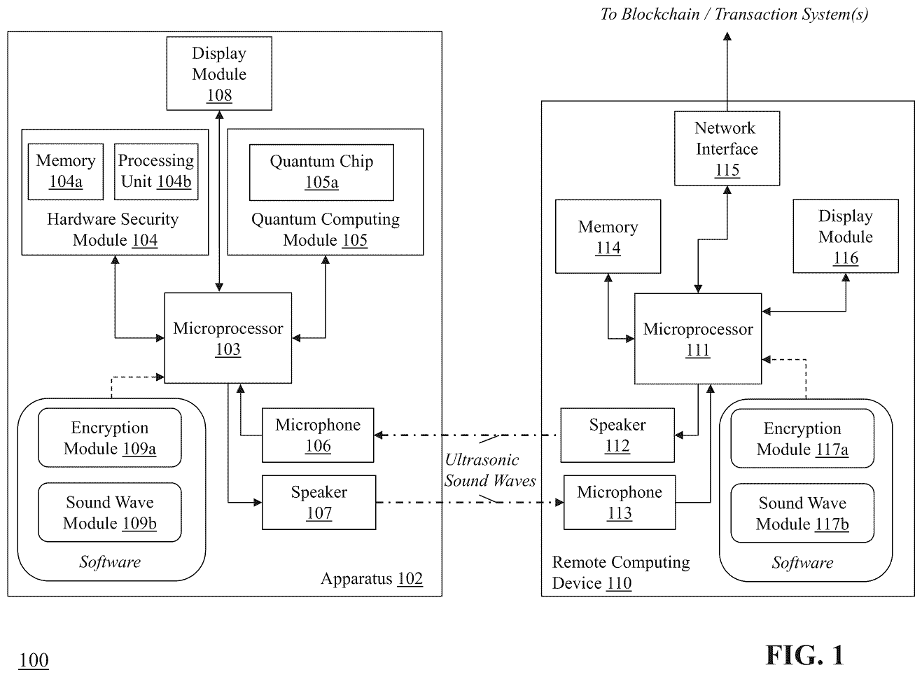

FIG. 1 is a block diagram of a system 100 for secure storage and transmission of a cryptocurrency encryption key. System 100 includes apparatus 102 with microprocessor 103, hardware security module (HSM) 104 having memory 104a and processing unit 104b (e.g., a processing chip), quantum computing module (QCM) 105 having a quantum chip 105a, microphone 106, speaker 107, and software comprising transaction module 108a and sound wave module 108b. As shown in FIG. 1, microprocessor 103 is coupled to each of HSM 104, QCM 105, microphone 106, speaker 107, and display module 108. Microprocessor 103 is also configured to execute software modules 109a and 109b. Also, it should be appreciated that apparatus 102 does not include components or circuitry that enable apparatus 102 to connect to a wired or wireless network. In some embodiments (including as shown in FIG. 1), the components of apparatus 102 are contained within a single device housing. In some embodiments, components 103, 104, 105, 106, 107, and 108 are coupled to and/or integrated into a circuit board that is contained within the single device housing and enables the components to communicate with each other.

System 100 also comprises remote computing device 110 that includes microprocessor 111, speaker 112, microphone 113, memory 114, network interface 115, display module 116 and software comprising transaction module 117a and sound wave module 117b. Exemplary remote computing devices 110 can include, but are not limited to, desktop computers, laptop computers, tablets, smartphones, mobile devices, edge computing devices, or other similar types of computing devices. As shown in FIG. 1, the components of remote computing device 110 are contained in a single device housing. However, in some embodiments one or more of the components of remote computing device 110 can comprise separate devices that are coupled to remote computing device. Remote computing device 110 can connect to one or more transaction system(s) (e.g., blockchain computing systems, cloud computing systems, etc.) via network interface 115.

Microprocessors 103 and 111 are specialized processing units configured to communicate with other components of their respective devices 102, 110 and process encrypted data for the purpose of creating cryptocurrency wallets, and signing and validating cryptocurrency-based transactions using data transmitted via ultrasonic sound waves. In some embodiments, one or more of microprocessors 103, 111 can comprise a single board computer that can support additional peripherals (e.g., Raspberry Pi). Also, in some embodiments, microprocessors 103, 111 are configured to perform elliptic curve cryptography (ECC) operations, such as verification and signature generation. An exemplary microprocessor 103, 111 can comprise a 64-bit chip set that supports ECC.

Hardware security module (HSM) 104 comprises a plurality of hardware components (e.g., memory 104a, processing unit 104b) that operate to store and safeguard encryption key data used by the other components of system 100 to communicate with remote computing device 110 for, e.g., generating, signing, and validating cryptocurrency-based transactions. For example, memory 104a can store the encryption key data and cryptographic processing algorithm(s), firmware and/or software used by processing unit 104b to generate, manage, and store the encryption key data. In some embodiments, HSM 104 comprises a tamper-resistant or tamper-proof design to prevent unauthorized access or intrusion attempts (e.g., hardened casing, seals that must be broken during intrusion to show evidence of tampering, and/or destruction or erasure of internal components if an intrusion is detected). HSM 104 can store certain types of encryption key data used by system 100, including public-private key pairs, apparatus-specific keys and other types of data. In one example, HSM 104 can store and encrypt a quantum-seeded private key for a cryptocurrency wallet generated using quantum computing module (QCM) 105.

Quantum computing module 105 comprises one or more hardware components (e.g., quantum chip 105a) that operate to generate a quantum random number that is used to seed a private key generated by HSM 104 for use in generation of cryptocurrency wallets, which is then used to create a public key transmissible to remote computing device 110 for creation of cryptocurrency deposit addresses of the wallet, and for execution and/or validation of cryptocurrency transactions. In some embodiments, quantum chip 105a can be implemented as a system-on-chip (SoC) design where a co-processor is coupled to a qubit array and enables microcprocessor 103 to interact with the qubits for generation of a quantum random number. In some embodiments, quantum chip 105a is embedded directly onto a circuit board of apparatus 102.

As shown in FIG. 1, as an additional security layer, apparatus 102 communicates with remote computing device 110 via ultrasonic sound waves for the transmission and receipt of data. Microphones 106, 113 are coupled to their respective microprocessors 103, 111 for the purpose of receiving ultrasonic sound waves from speakers 107, 112 of the corresponding device 102, 110 and transmitting a digital representation of the received ultrasonic sound waves to microprocessors 103, 111 for processing. In some embodiments, microphones 106, 113 comprise specialized ultrasonic sensors that capture and measure ultrasonic waves at close range, and can be embedded in their respective devices 102, 110. Speakers 107, 112 are coupled to their respective microprocessors 103, 11 for the purpose of generating ultrasonic sounds waves and transmitting the sound waves to microphones 106, 113 of the corresponding device 102, 110. In some embodiments, speakers 107, 112 are embedded in their devices 102, 110. In some embodiments, ultrasonic sound waves comprise short-range sound waves that can only be transmitted and detected between devices 102, 110 when these devices are placed in close proximity to each other. As a result, the short-range ultrasonic sound waves beneficially prevent eavesdropping, snooping, or interception of the sound waves by malicious third party devices. Also, as mentioned previously, the use of ultrasonic sound waves is more secure than other mechanisms for transmitting data between apparatus 102 and remote computing device 110, such as quick response (QR) codes or other visual elements that are scanned and may be viewed and parsed by unintended recipients. Further details about the generation, emission, receipt, and processing of these ultrasonic sound waves by apparatus 102 and remote computing device 110 are described throughout the specification.

Display module 108 comprises hardware to enable apparatus 102 to generate visual elements (e.g., user interfaces) for display to a user of apparatus 102. For example, display module 108 can comprise a graphics processing unit that is configured to render a user interface via a corresponding touchscreen that is embedded in apparatus 102. A user of apparatus 102 can interact with the touchscreen to perform functions such as requesting generation of a new wallet, signing cryptocurrency transactions, viewing cryptocurrency wallet balances, and the like.

As mentioned above, apparatus 102 comprises software modules (encryption module 109a, sound wave module 109b) and remote computing device 110 comprises software modules (encryption module 117a, sound wave module 117b) that are executed by the respective microprocessors 103, 111 to perform specific functions for the purpose of secure storage and transmission of a cryptocurrency encryption key. In some embodiments, software modules 109a, 109b, 117a, and 117b are specialized modules executed by microprocessors 103, 111 to interact with other components of the respective devices 102, 110 in order to prepare, process, encrypt, decrypt, transform, convert, and/or generate data associated with the functions described herein. As just one example, sound wave module 109b can be executed by microprocessor 103 to convert encryption key data, pairing data, and/or other data stored in HSM 104 or generated by microprocessor 103 into a corresponding signal that is transmitted to speaker 107 for generation of ultrasonic sound waves and emission of the ultrasonic sound waves that can be detected by microphone 113 of remote computing device 110. Once received, microphone 113 transmits a signal corresponding to the ultrasonic sound waves to microprocessor 111, which executes sound wave module 117b to convert the signal into, e.g., encryption key data, pairing data, etc. that can be processed by microprocessor 111 as described herein. In some embodiments, encryption modules 109a, 117a can comprise software to enable the respective microprocessors 103, 111 to generate and store encryption key pairs in memory 104a, and encrypt, decrypt, and/or validate cryptocurrency transaction-related data.

As mentioned above, network interface 115 comprises circuitry and/or related components to enable remote computing device 110 to communicate with one or more other computing systems, such as blockchains, cryptocurrency exchanges, transaction systems and the like. Network interface 115 can include hardware to enable wired and/or wireless network communications over one or more communications networks (e.g., cellular, Internet). Display module 116 comprises hardware to enable remote computing device 110 to generate visual elements (e.g., user interfaces) for display to a user of remote computing device 110. For example, display module 116 can comprise a graphics processing unit that is configured to render a user interface via a corresponding display device (e.g., embedded screen, monitor coupled to remote computing device 110, etc.).

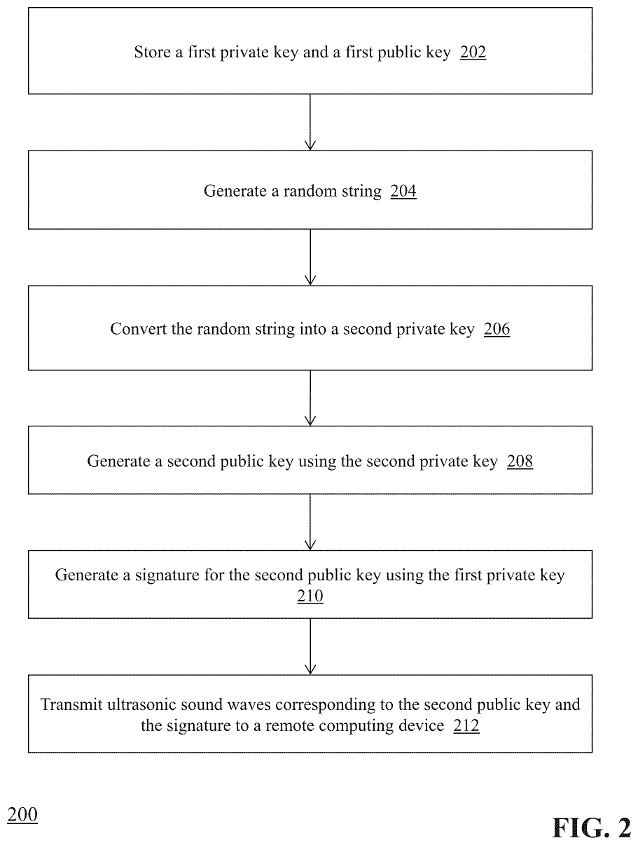

FIG. 2 is a flow diagram of a computerized method 200 of secure storage and transmission of a cryptocurrency encryption key, using the system 100 of FIG. 1. As can be appreciated, in some embodiments apparatus 102 can be used to securely generate a private key for a new cryptocurrency wallet and use that private key to create a corresponding public key that is transmitted to remote computing device 110 for generation of corresponding cryptocurrency deposit address(es). Memory 104a of hardware security module 104 stores (step 202) a first private key and a first public key. In some embodiments, the first private key and first public key comprise an HSM encryption key pair used by apparatus 102 to, e.g., generate and validate key signatures, encrypt private keys for wallet(s) on apparatus 102, and securely store cryptocurrency encryption keys in memory 104a. As mentioned previously, apparatus 102 and HSM 104 can be configured to utilize ECC for encryption. As can be appreciated, the private key-public key pair is unique to HSM 104 and in some embodiments, the private key-public key pair is stored on HSM 104 during manufacture or configuration. An advantage of using hardware security module 104 to store the first private key and first public key is that the first private key cannot be accessed unless the HSM 104 is tampered with, and using certain tamper-resistant or tamper-proof designs (as described above) provides an additional layer of protection for the first private key and other cryptocurrency encryption keys stored in memory 104a.

Quantum chip 105a of quantum computing module (QCM) 105 generates (step 204) a random string that is used as a seed to generate a second private key associated with a cryptocurrency wallet. As can be appreciated, the second private key is then used to create a corresponding second public key, which is then used to create a signature for transmission to remote computing device 110. Remote computing device 110 then uses the second public key and the signature to generate cryptocurrency deposit addresses for the cryptocurrency wallet. In some embodiments, the second private key is a 256-bit random number. In other embodiments, the second private key is a 256-bit random alphanumeric value.

In some embodiments, microprocessor 103 is configured to verify that HSM 104 and/or QCM 105 is operational and not compromised prior to executing any process steps. For example, microprocessor 103 can communicate with HSM 104 and/or QCM 105 to confirm that HSM 104 and QCM 105 are functioning properly and have not detected any tampering or intrusion attempts. When microprocessor 103 determines that either HSM 104 or QCM 105 is not operational or has been tampered with, microprocessor 103 can end any further processing steps. In some embodiments, microprocessor 103 is configured to validate the integrity of software or firmware installed on HSM 104 as part of the verification process. In addition, microprocessor 103 can validate the integrity of software modules 109a, 109b prior to initiating execution of any subsequent processing steps. If one of these integrity checks fails, apparatus 102 can issue an alert using, e.g., display device 109 and cancel any further processing.

Microprocessor 103 then converts (step 206) the random string generated by quantum chip 105a into a second private key. For example, microprocessor 103 converts the random string to an ECC-based private key using one or more elliptic-curve encryption algorithms or schemes. Using the ECC-based private key, microprocessor 103 generates (step 208) a corresponding second public key—resulting in a second private key-public key pair. In some embodiments, microprocessor 103 passes the second private key to HSM 104, which encrypts the second private key using the first private key stored in memory 104a. HSM 104 can then store the encrypted second private key in memory 104a. Microprocessor 103 transmits the second public key to HSM 104, which generates (step 210) a signature based upon the second public key using the first private key of the HSM 104 stored in memory 104a.

Once the second public key and the signature are generated, microprocessor 103 generates one or more data packets for transmission to remote computing device 109 via ultrasonic sound waves. In some embodiments, microprocessor 103 identifies a software version (e.g., version number, version identifier) associated with, e.g., HSM 104, QCM 105 and/or software modules 109a, 109b. Microprocessor 103 then combines the data elements into a serializable object (e.g., one or more packets)—an exemplary packet structure generated by microprocessor 103 can be:
<Packet Header><Software Version><Second Public Key><Signature>

After the one or more packets are generated, microprocessor 103 activates speaker 107 and converts the packets into a signal that is provided to speaker 107 for generation and emission of ultrasonic waves corresponding to the packet data. Speaker 107 transmits (step 212) the ultrasonic waves for receipt by microphone 113 of remote computing device 110. In some embodiments, speaker 107 remains active until receiving an end signal instruction from microprocessor 103, at which point speaker 107 stops transmitting ultrasonic sound waves and deactivates.

Prior to transmission of the ultrasonic sound waves by speaker 107, remote computing device 110 is configured to listen for the sound waves. For example, when apparatus 102 is placed in proximity to remote computing device 110, a user of remote computing device 110 can instruct microprocessor 111 to activate microphone 113, which will begin listening for sound waves in the ultrasonic range (e.g., a frequency from 20 kHz to approximately several gHz). When ultrasonic waves are detected, microphone 113 generates a signal that is provided to microprocessor 111 for parsing. In some embodiments, microprocessor 111 determines whether the received packet(s) are complete and usable (e.g., the packets contain a complete second public key and signature). If so, microprocessor 111 can store the received second public key and signature in memory 114.

Before creating the cryptocurrency deposit addresses for the cryptocurrency wallet, microprocessor 111 can verify information received from apparatus 102, including validation of the software version (i.e., confirm that the version received is the same as an expected version) and verification of the signature. If either the software version or the signature does not pass validation, remote computing device 110 can end processing without generation of the deposit addresses. If the software version and the signature are valid, microprocessor 111 can generate one or more cryptocurrency deposit addresses using the second public key and store the corresponding deposit addresses in memory 114.

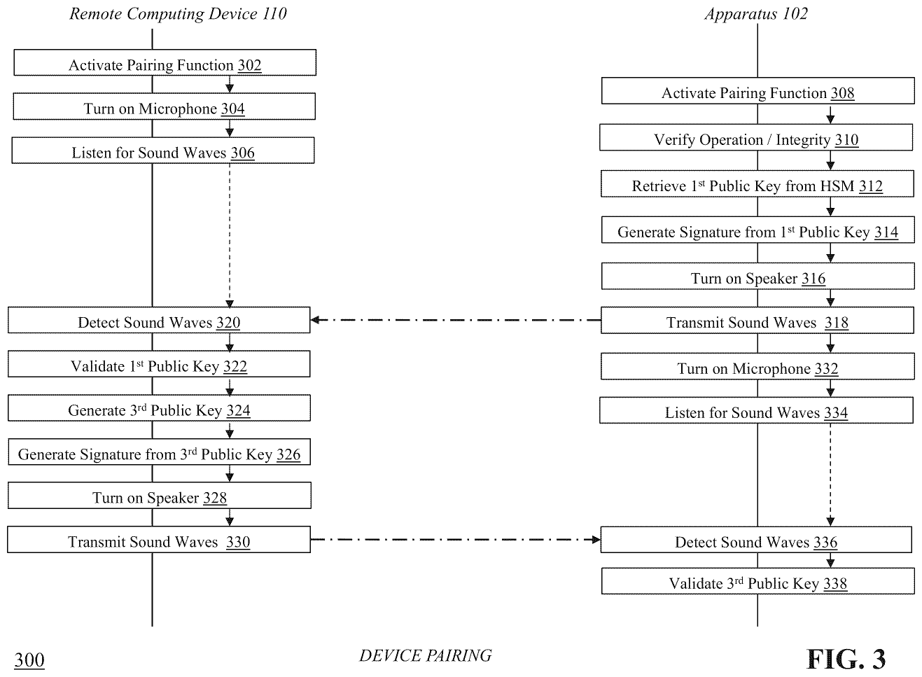

After a cryptocurrency wallet is created at apparatus 102 and the corresponding deposit addresses are stored on remote computing device 110, system 100 can execute workflows to, e.g., securely execute, sign, and validate cryptocurrency transactions associated with the wallet. FIG. 3 is a workflow diagram of a computerized method 300 of pairing apparatus 102 with remote computing device 110 using a secure handshake process. As shown in FIG. 3, a user of remote computing device 110 activates a pairing function (step 302) to initiate the handshake process. In one example, the user of device 110 can press a button on the device (e.g., a virtual button displayed in a user interface or a physical button on the device) to activate the pairing function. Microprocessor 103 then turns on microphone 113 (step 304) and begins listening for ultrasonic sound waves being emitted by apparatus 102 (step 306).

As remote computing device 110 listens for ultrasonic sound waves, apparatus 102 activates a pairing function (step 308). For example, the pairing function at apparatus 102 can be automatically activated when apparatus 102 is first powered on. In another example, the pairing function can be activated in response to an interaction with apparatus 102 by the user—e.g., a button press. When the pairing function is activated, apparatus 102 can perform one or more verification routines (step 310) to ensure proper operation and integrity of certain components of apparatus 102. For example, microprocessor 103 can communicate with HSM 104 to verify that HSM 104 is operational and has not been compromised or tampered with—e.g., microprocessor 103 can validate that software, firmware and/or other data stored in memory 104a is valid, microprocessor 103 can confirm that processing unit 104b is working normally and has not been altered or damaged, etc. In some embodiments, microprocessor 103 can also verify that QCM 105 is operational and has not be compromised—including validation that quantum chip 105a is performing as expected. Furthermore, in some embodiments, microprocessor 103 can validate the software—including modules 109a and 109b—stored on the apparatus 102 to ensure that the software is installed properly, has the correct version number, does not contain any malicious code, etc. The validation process beneficially provides an additional layer of protection and security for apparatus 102—in the event that any of the validation processes fails, apparatus 102 can notify the user (e.g., via the display screen) that apparatus 102 may be malfunctioning or corrupted, so that the user can avoid proceeding with any operations or transactions using apparatus 102.

Upon successful completion of the verification routines, microprocessor 103 retrieves the HSM's public key (i.e., as described above, the first public key) from HSM 104—including any necessary decryption or parsing of the first public key. Microprocessor 103 then provides the first public key back to HSM 104 to generate a corresponding signature (step 314) using HSM 104. When the signature is created, microprocessor 103 generates one or more packets comprising the first public key and the signature. In some embodiments, microprocessor 103 also determines a software version of one or more components of apparatus 102 (software modules 109a, 109b; HSM 104; QCM 105) and includes the software version in the packets.

Microprocessor 103 powers on speaker 107 (step 316) and uses sound wave module 109b to convert the packets into a digital signal transmitted to speaker 107 for emission of corresponding ultrasonic sound waves. Speaker 107 transmits the ultrasonic sound waves (step 318) which are detected by microphone 113 of remote computing device 110 (step 320). In some embodiments, microprocessor 103 includes an end-of-transmission signal or code in the transmission in order to indicate to remote computing device 110 that data transmission is complete and remote computing device 110 can instruct microphone 113 to cease listening for sound waves.

Upon detecting the sound waves, microphone 113 transmits a signal to microprocessor 111, which converts the sound wave signal into corresponding data packets and parses the data packets to obtain the first public key and the signature sent from apparatus 102. Microprocessor 111 then validates the first public key (step 322) using the provided signature. In some embodiments, microprocessor 111 also verifies the software version information contained in the packets received from apparatus 102.

When the first public key is successfully validated, microprocessor 111 generates a public key for apparatus 102 (also called the third public key) using, e.g., a local certificate stored on apparatus 102 (step 324). Microprocessor 111 generates a signature for apparatus 102 using the third public key (step 326), and creates one or more packets comprising the third public key and the signature. Microprocessor 111 powers on speaker 112 (step 328), and uses sound wave module 117b to convert the packets into a digital signal transmitted to speaker 112 for emission of corresponding ultrasonic sound waves. Speaker 112 transmits the ultrasonic sound waves (step 330). Prior to or concurrently with this transmission, microprocessor 103 powers on microphone 106 (step 332) and listens for sound waves (step 334) emitted from remote computing device 110. The sound waves are detected by microphone 106 (step 336), which transmits a signal to microprocessor 103, which converts the sound wave signal into corresponding data packets and parses the data packets to obtain the third public key and the signature sent from remote computing device 110. Microprocessor 103 validates the third public key 338 using the provided signature, and stores the third public key in, e.g., local memory. The devices 102, 110 are now paired and can be used to generate, execute, sign, and/or validate one or more cryptocurrency transactions.

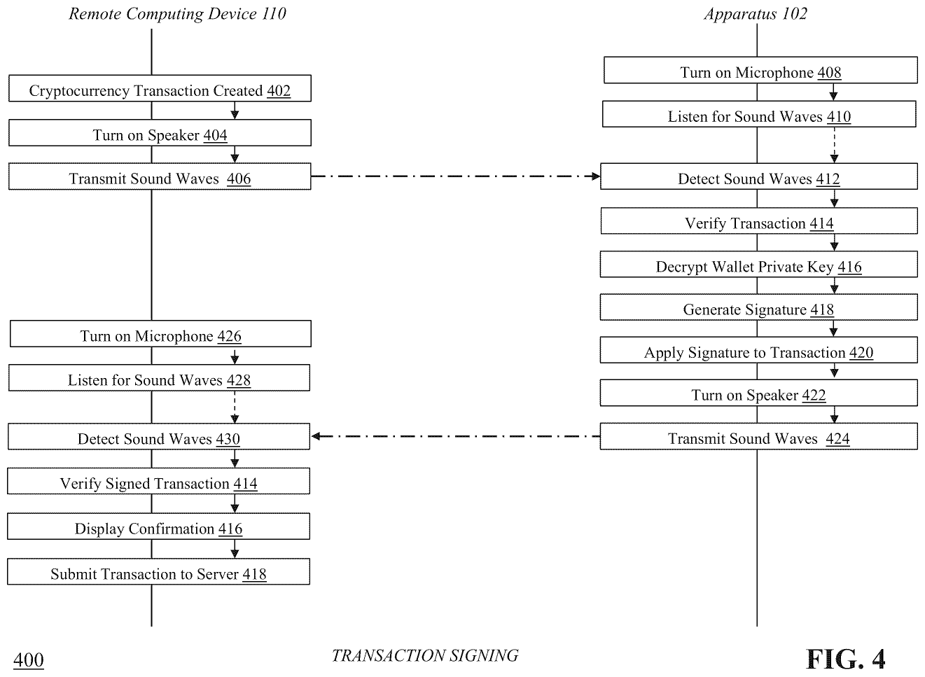

FIG. 4 is a workflow diagram of a computerized method 400 of signing a cryptocurrency transaction using system 100. It should be appreciated that the method 400 of FIG. 4 can be executed after the pairing process described above in FIG. 3, or in some embodiments prior to pairing as will be described below. Microprocessor 111 of remote computing device 110 creates a cryptocurrency transaction (step 402) that will be signed using apparatus 102. For example, a user at remote computing device 110 can communicate with one or more transaction server(s) to initiate a cryptocurrency transaction using available funds. Upon initiating the transaction, remote computing device 110 conducts the pairing process of FIG. 3 with apparatus 102. If the devices 102, 110 are already paired, this step can be omitted.

Microprocessor 110 converts the proposed transaction into one or more packets, including certain details of the transaction (e.g., currency type, amount, etc.) In some embodiments, the transaction data includes a signature that can be used by apparatus 102 to verify the transaction. Microprocessor 110 powers on speaker 112 (step 404). Microprocessor 111 uses sound wave module 117b to convert the packets into a digital signal transmitted to speaker 112 for emission of corresponding ultrasonic sound waves. Speaker 112 transmits the ultrasonic sound waves (step 406) to apparatus 102. Prior to or concurrently with this transmission, microprocessor 103 powers on microphone 106 (step 408) and listens for sound waves (step 410) emitted from remote computing device 110. The sound waves are detected by microphone 106 (step 412), which transmits a signal to microprocessor 103 to convert the sound wave signal into corresponding data packets. Microprocessor 103 parses the data packets to obtain the transaction data and the signature sent from remote computing device 110.

Microprocessor 103 of apparatus 102 verifies the transaction (step 414) using the provided signature information, and upon successful verification, microprocessor 103 communicates with HSM 104 to decrypt the cryptocurrency wallet private key that is stored in memory 104a (step 416). Using the private key, HSM 104 generates a signature (step 418) and microprocessor 103 applies the signature to the transaction (step 420).

Microprocessor 103 then generates one or more packets comprising the signed transaction and a signature for verification, powers on speaker 107 (step 422) and uses sound wave module 109b to convert the packets into a digital signal transmitted to speaker 107 for emission of corresponding ultrasonic sound waves. Speaker 107 transmits the ultrasonic sound waves (step 318) which are detected by microphone 113 of remote computing device 110 (step 320). Prior to or concurrently with this transmission, microprocessor 110 powers on microphone 113 (step 426) and listens for sound waves (step 428) emitted from apparatus 102. The sound waves are detected by microphone 113 (step 430), which transmits a signal to microprocessor 111 to convert the sound wave signal into corresponding data packets. Microprocessor 111 parses the data packets to obtain the signed transaction data and the verification signature sent from apparatus 112.

Microprocessor 111 verifies the signed transaction (step 414) received from apparatus 102, and displays a confirmation screen using display module 116 to a user of remote computing device 110. In some embodiments, the display screen shows the user the relevant transaction details and provides an input element that asks the user to confirm execution of the transaction. Upon detecting said input, microprocessor 111 submits the verified transaction to one or more transaction server(s) and/or blockchain server(s) for processing (step 418).

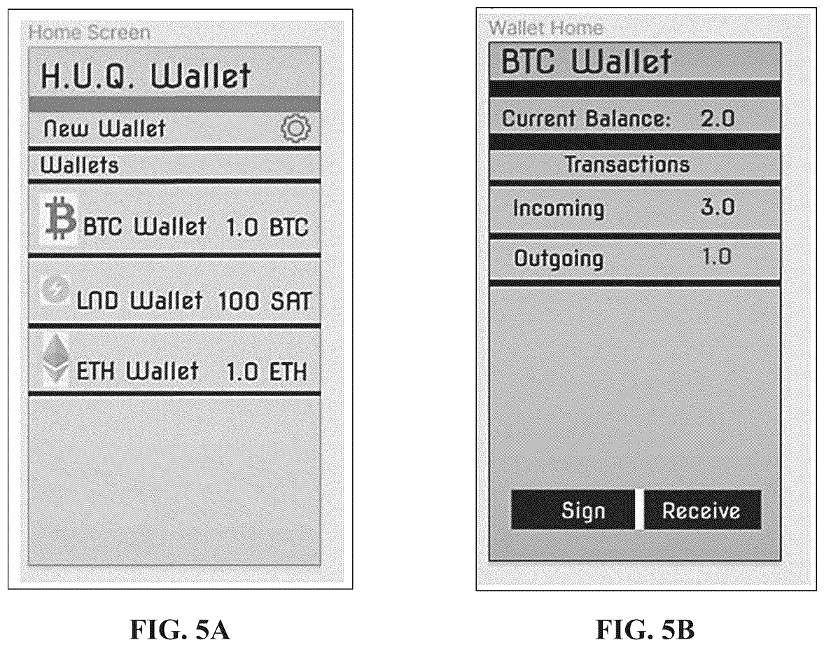

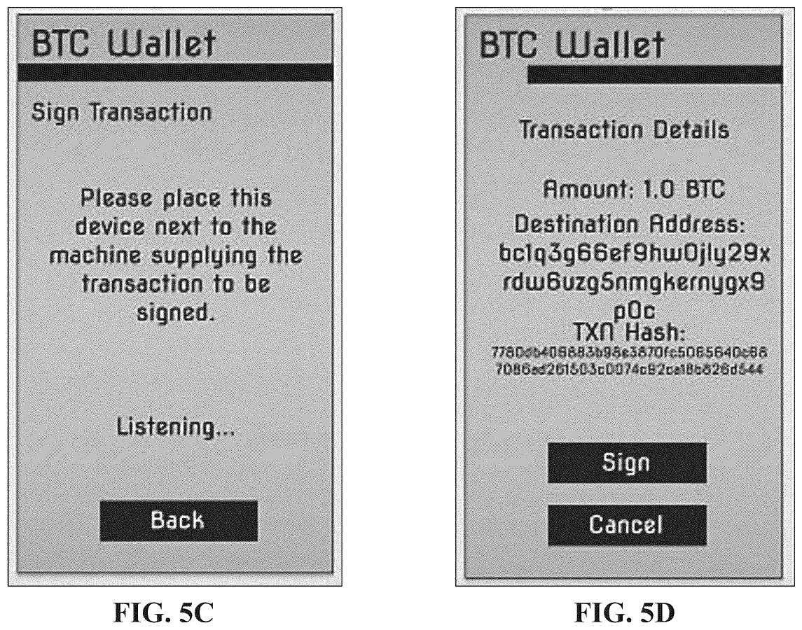

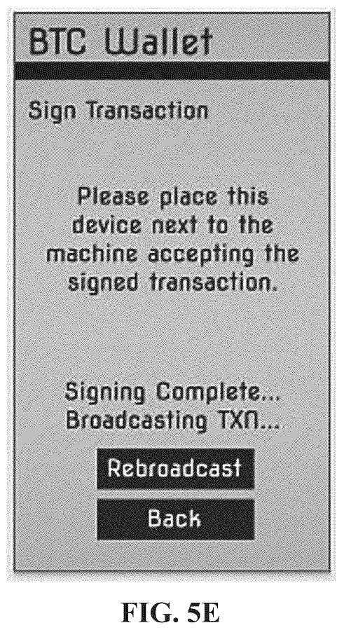

FIGS. 5A to 5E are diagrams of exemplary user interface screens generated by apparatus 102 during signing of a cryptocurrency transaction. As can be appreciated, microprocessor 103 can generate the user interface screens via display module 108 for display to a user of apparatus 102. FIG. 5A is a user interface screen that displays a cryptocurrency wallet summary screen. As shown, the summary screen includes a listing of each cryptocurrency wallet that has a private key stored in HSM 104 of apparatus 102 (e.g., Bitcoin (BTC), Lendingblock (LND), Etherium (ETH)) along with corresponding currency balances. In addition, the user interface screen includes an option for the user to create a new wallet (as described previously). The user can select one of the wallets (e.g., BTC) by tapping the area of the screen associated with the wallet to view additional information about the wallet.

FIG. 5B is a user interface screen that displays a summary of transactions associated with the selected wallet. As shown, the user has selected the BTC wallet and apparatus 102 displays a summary of incoming and outgoing transactions for the BTC wallet. The user interface also includes a Sign button for the user to, e.g., sign an outgoing transaction using the apparatus 102; and a Receive button for the user to receive an incoming transaction. Upon selecting the Sign button, microprocessor 103 of apparatus 102 generates the user interface of FIG. 5C.

FIG. 5C is a user interface screen that displays a prompt for the user to place apparatus 102 next to the device that is supplying the transaction to be signed (i.e., remote computing device 110). As shown, apparatus 102 asks the user to place the device next to a device that will be supplying the transaction and indicates to the user that microphone 106 is activated and is listening for ultrasonic sound waves from speaker 112 of remote computing device 110. Once the ultrasonic sound waves are detected by microphone 106 and microprocessor 103 has parsed the received transaction, microprocessor 103 generates the user interface of FIG. 5D.

FIG. 5D is a user interface screen that displays transaction details to the user for confirmation and signature. As shown, the user interface displays relevant information (e.g., transaction amount, currency type, destination wallet address, and transaction hash value. The user can review the information and, if they want to proceed with the transaction, the user selects the Sign button. Alternatively, the user can select the Cancel button to end the process without signing. When the user selects the Sign button, microprocessor 103 generates the user interface of FIG. 5E.

FIG. 5E is a user interface screen that displays a prompt for the user to place apparatus 102 next to a device that is accepting the signed transaction (i.e., remote computing device 110). As shown, apparatus 102 asks the user to place the device next to a device that will be accepting the signed transaction and indicates to the user that speaker 107 is activated and is transmitting ultrasonic sound waves comprising the signed transaction (including, e.g., the transaction hash value) to microphone 113 of remote computing device 110. Once the ultrasonic sound waves are detected by microphone 113 and microprocessor 111 has parsed and verified the signed transaction, microprocessor 111 submits the transaction to, e.g., a transaction server using network interface 115.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1-14. (canceled)

15. A computerized method of secure storage and transmission of a cryptocurrency encryption key, the method comprising:
activating, by a first computing device, a first pairing function in response to user input, the first pairing function comprising:
analyzing one or more software modules installed on the first computing device to capture a software version number of the software modules and confirm that the software version number is correct,
generating, using a security module in the first computing device, a signature from a first private key stored in the security module,
encoding first packets comprising the first public key, the first signature, and the software version number, and
transmitting, using a speaker of the first computing device, ultrasonic sound waves corresponding to the first packets to a second computing device;
activating, by the second computing device, a second pairing function in response to user input, the second pairing function comprising:
listening for the ultrasonic sound waves corresponding to the first packets using a microphone of the second computing device,
converting the ultrasonic sound waves corresponding to the first packets into second packets and parsing the second packets to obtain the first public key, the first signature, and the software version number,
validating the first public key using the first signature and verifying that the software version number is correct,
generating a third public key using a certificate and generating a signature using the third public key,
encoding third packets comprising the third public key and the second signature, and
transmitting, using a speaker of the second computing device, ultrasonic sound waves corresponding to the third packets to a microphone of the first computing device,
wherein, during the first pairing function, the first computing device further:
listens for the ultrasonic sound waves corresponding to the third packets using a microphone of the first computing device,
converts the ultrasonic sound waves corresponding to the third packets into fourth packets and parses the fourth packets to obtain the third public key and the second signature, and
validates the third public key using the second signature and stores the third public key in local memory;
activating, by the first computing device, a cryptocurrency wallet creation function in response to user input, the cryptocurrency wallet creation function comprising:
generating, by a quantum chip of a quantum computing module, a random string,
converting the random string into a second private key,
creating a second public key using the second private key when the pairing function confirms that the software version number is correct,
encrypting the second private key using the first private key,
encoding, fifth packets comprising the second public key, the first signature, and the software version number, the fifth packets signed using the first signature, and
transmitting, by the speaker of the first computing device, ultrasonic sound waves corresponding to the fifth packets to the microphone of the second computing device;
wherein, during the cryptocurrency wallet creation function, the second computing device:
listens for the ultrasonic sound waves corresponding to the fifth packets using the microphone of the second computing device,
converts the ultrasonic sound waves corresponding to the fifth packets into sixth packets and parses the sixth packets to obtain the second public key, the first signature, and the software version number,
validates the second public key using the first signature and verifies that the software version number is correct,
generates one or more cryptocurrency deposit addresses using the second public key, and
stores the second public key, the first signature, and the cryptocurrency deposit addresses in local memory.

16. The method of claim 15, further comprising listening, by the microphone of the first computing device, for ultrasonic sound waves corresponding to a cryptocurrency signing transaction transmitted from the second computing device.

17. The method of claim 16, further comprising converting, by the first computing device, the ultrasonic sound waves corresponding to the cryptocurrency signing transaction received by the microphone into unsigned cryptocurrency transaction data.

18. The method of claim 17, further comprising generating, by the first computing device, a transaction signature using the second private key and signing the unsigned cryptocurrency transaction data using the transaction signature.

19. The method of claim 18, further comprising decrypting, by the security module, the second private key before the first computing device generates the transaction signature.

20. The method of claim 18, further comprising transmitting, by the first speaker, ultrasonic sound waves corresponding to the signed cryptocurrency transaction data and the transaction signature to the second computing device.

21-22. (canceled)

23. The method of claim 15, wherein the random string comprises a 256-bit random number.

24-26. (canceled)

27. The method of claim 15, wherein the first computing device comprises a microprocessor that is embedded in a circuit board that connects the microprocessor to the security module, the quantum computing module, the speaker of the first computing device, and the microphone of the first computing device.

28. The method of claim 27, wherein the circuit board, the microprocessor, the security module, the quantum computing module, the speaker of the first computing device, and the microphone of the first computing device are within a single device housing.

29-31. (canceled)

32. The method of claim 15, wherein the second computing device generates an alert notification when the software version number received from the first computing device cannot be validated and displays the alert notification to a user of the second computing device.

33. A system for secure storage and transmission of a cryptocurrency encryption key, the system comprising:
a first computing device comprising a microprocessor, a local memory, a security module storing a first private key and a first public key, a quantum computing module comprising a quantum chip with one or more qubits, a speaker, and a microphone;
a second computing device a microprocessor, a local memory, a speaker, and a microphone;
wherein the first computing device activates a first pairing function in response to user input, the first pairing function comprising:
analyzing one or more software modules installed on the first computing device to capture a software version number of the software modules and confirm that the software version number is correct,
generating, using the security module, a signature from the first private key,
encoding first packets comprising the first public key, the first signature, and the software version number, and
transmitting, using the speaker of the first computing device, ultrasonic sound waves corresponding to the first packets to the second computing device;
wherein the second computing device activates a second pairing function in response to user input, the second pairing function comprising:
listening for the ultrasonic sound waves corresponding to the first packets using the microphone of the second computing device,
converting the ultrasonic sound waves corresponding to the first packets into second packets and parsing the second packets to obtain the first public key, the first signature, and the software version number,
validating the first public key using the first signature and verifying that the software version number is correct,
generating a third public key using a certificate and generating a signature using the third public key,
encoding third packets comprising the third public key and the second signature, and
transmitting, using the speaker of the second computing device, ultrasonic sound waves corresponding to the third packets to the microphone of the first computing device,
wherein, during the first pairing function, the first computing device further:
listens for the ultrasonic sound waves corresponding to the third packets using the microphone of the first computing device,
converts the ultrasonic sound waves corresponding to the third packets into fourth packets and parses the fourth packets to obtain the third public key and the second signature, and
validates the third public key using the second signature and stores the third public key in the local memory of the first computing device;
wherein the first computing device activates a cryptocurrency wallet creation function in response to user input, the cryptocurrency wallet creation function comprising:
generating, by the quantum chip, a random string,
converting the random string into a second private key,
creating a second public key using the second private key when the pairing function confirms that the software version number is correct,
encrypting the second private key using the first private key,
encoding fifth packets comprising the second public key, the first signature, and the software version number, the fifth packets signed using the first signature, and
transmitting, by the speaker of the first computing device, ultrasonic sound waves corresponding to the fifth packets to the microphone of the second computing device;
wherein, during the cryptocurrency wallet creation function, the second computing device:
listens for the ultrasonic sound waves corresponding to the fifth packets using the microphone of the second computing device,
converts the ultrasonic sound waves corresponding to the fifth packets into sixth packets and parses the sixth packets to obtain the second public key, the first signature, and the software version number,
validates the second public key using the first signature and verifies that the software version number is correct,
generates one or more cryptocurrency deposit addresses using the second public key, and
stores the second public key, the first signature, and the cryptocurrency deposit addresses in the local memory of the second computing device.
